(19) United States
(12) Patent Application Publication
(10) Pub. No.: US 2016/0070309 A1
(43) Pub. Date: Mar. 10, 2016

(54) ELECTRONIC DEVICE ENCLOSURE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: MIN YANG, Wuhan (CN); XIN-SHU WANG, Wuhan (CN); JIAN-HUNG HUNG, New Taipei (TW)

(21) Appl. No.: 14/525,968

(22) Filed: Oct. 28, 2014

(30) Foreign Application Priority Data
Sep. 5, 2014 (CN) 201410450903.X

(51) Int. Cl. G06F 1/16

(52) U.S. Cl. CPC G06F 1/1679; G06F 1/1696

(57) ABSTRACT

An electronic device enclosure includes a cover, a base, a locking member mounted to the cover, a sensing member mounted to the base, and a control device mounted to the base. The base defines a receiving portion. The locking member is capable of being received in the receiving portion after the cover rotates toward the base. The sensing member is triggered after being received in the receiving portion. The control device controls the locking member to lock in the receiving portion after the sensing member is triggered, thereby preventing the cover from rotating away from the base.

### FIELD

The subject matter herein generally relates to an electronic device enclosure.

### BACKGROUND

An electronic device enclosure is used to protect electronic devices such as a notebook computer.

### BRIEF DESCRIPTION OF THE DRAWINGS

Implementations of the present technology will now be described, by way of example only, with reference to the attached figures.

FIG. 1 is a block diagram of one embodiment of an electronic device enclosure with a keyboard.

FIG. 2 is a diagrammatic view of a base of FIG. 1.

FIG. 3 is an isometric view of a cover of FIG. 1.

FIG. 4 is an isometric view of the electronic device enclosure of FIG. 1, and the cover is open.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “comprising, but not necessarily limited to”; it specifically indicates open-ended inclusion or membership in the so-described combination, group, series and the like.

The present disclosure is described in relation to an electronic device enclosure for protecting a notebook computer.

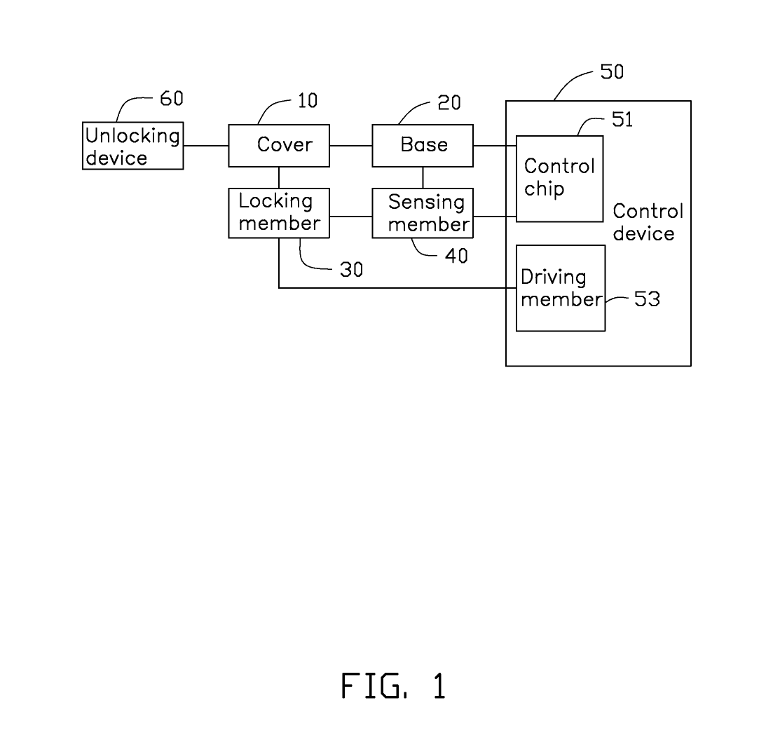

FIG. 1 illustrates an embodiment of an electronic device enclosure. The electronic device enclosure comprises a cover 10, a base 20, a locking member 30 mounted to the cover 10, a sensing member 40 mounted to the base 20, and a control device 50. The control device 50 comprises a control chip 51 and a driving member 53. An unlocking device 60 is mounted to the cover 10. In at least one embodiment, the sensing member 40 is a pressure sensor, the control chip 51 is an embedded controller (EC), the driving member 53 is a motor, and the unlocking device 60 is a fingerprint identification device.

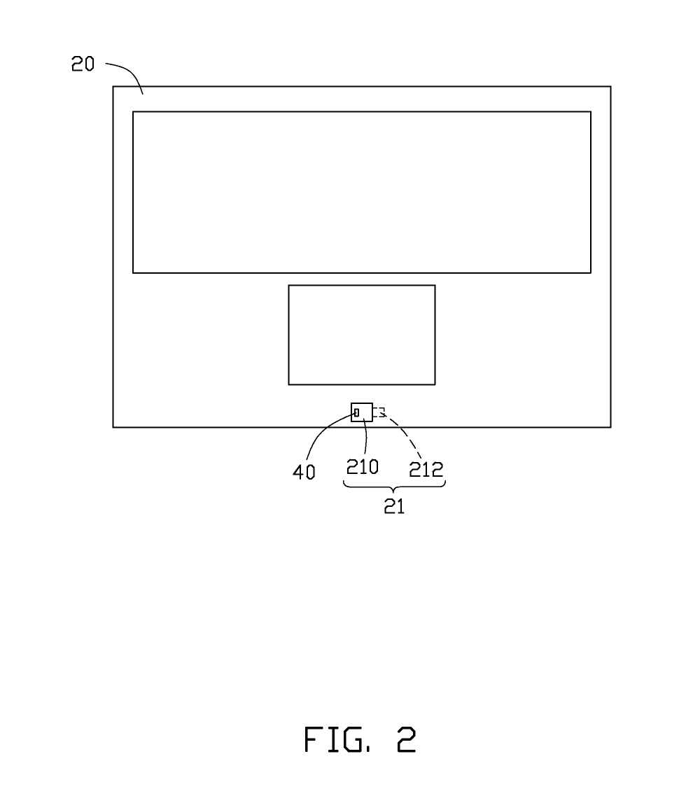

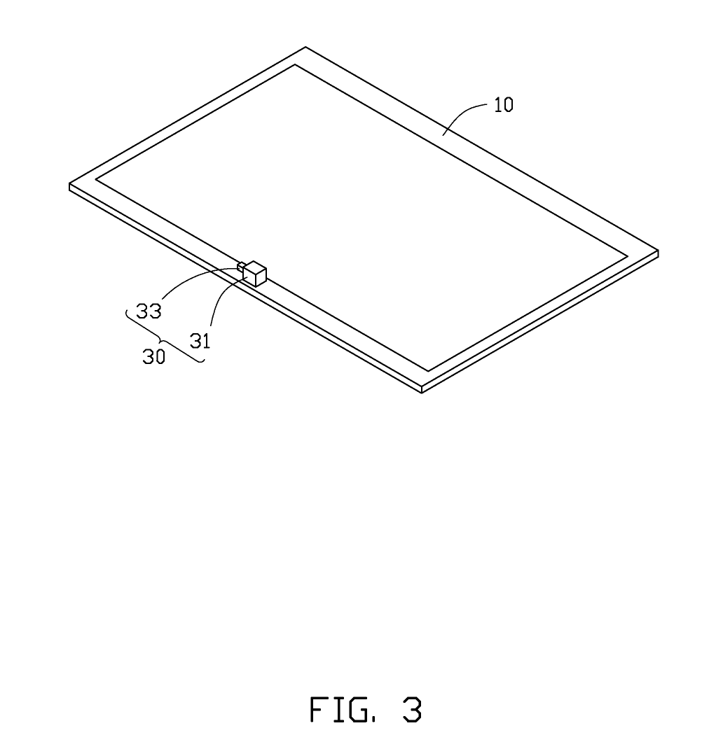

FIGS. 2 and 3 illustrate that a side of the base 20 is coupled to a side of the cover 10. The other side of the base 20 defines a receiving portion 21. The receiving portion 21 is substantially L-shaped and is defined inwardly from the base 20. The receiving portion 21 comprises a sensing portion 210 and an engaging portion 212 extending perpendicularly from the sensing portion 210.

The locking member 30 comprises a mounting portion 31 mounted to the cover 10 and a locking portion 33 movably coupled to the mounting portion 31. The locking portion 33 is configured to be received in the mounting portion 31 driven by the driving member 53 and is configured to extend out of the mounting portion 31 driven by the driving member 53. The mounting portion 31 corresponds to the sensing portion 210. The locking portion 33 corresponds to the engaging portion 212.

The unlocking device 60 is configured to collect fingerprint information from one or more users and store a reference range corresponding to the fingerprint information of the users. The unlocking device 60 is configured to receive a current value after sensing the fingerprint information and compares the current value with the reference range. The unlocking device 60 sends an open signal to the control chip 51 when the current value is within the reference range.

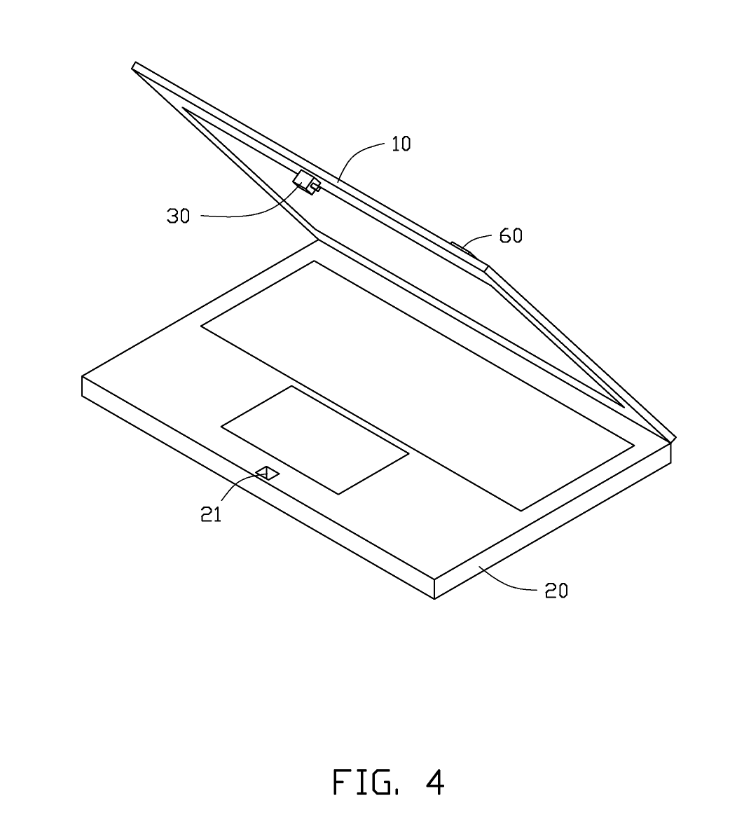

FIG. 4 illustrates when using the electronic device enclosure, the cover 10 is operated to rotate toward the base 20. The mounting portion 31 is received in the sensing portion 210 to resist and press the sensing portion 210, to trigger the sensing member 40. The cover 10 is closed. The sensing member 40 sends a closed signal to the control chip 51. The control chip 51 drives the driving member 53 after receiving the closed signal. The driving member 53 drives the locking portion 33 to extend out of the mounting portion 31 to the locking portion 33. The locking member 30 is locked in the receiving portion 21 to prevent the cover 10 from rotating away from the base 20, thereby preventing the cover 10 from being opened. The unlocking device 60 receives the current value after sensing the fingerprint information and compares the current value with the reference range. The unlocking device 60 sends the open signal to the control chip 51 when the current value is within the reference range. The control chip 51 drives the driving member 53 after receiving the open signal. The driving member 53 controls the locking portion 33 to extend into the mounting portion 31. The locking portion 33 disengages from the engaging portion 210. The cover 10 can be rotated away from the base 20 to open.

In the embodiment, the cover 10 is rotated toward the base 20 to enable the mounting portion 31 to be received in the receiving portion 21, then the sensing member 40 sends the closed signal to the control chip 51. The control chip 51 drives the driving member 53 to control the locking portion 33 to extend out of the mounting portion 31 to engage the engaging portion 212. The locking member 30 is locked in the receiving portion 21 to prevent the cover 10 from rotating away from the base 20, thereby preventing the cover 10 from being opened.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An electronic device enclosure comprising:
a cover;
a base defining a receiving portion;
a locking member mounted to the cover;
a sensing member mounted to the base; and
a control device mounted to the base,
wherein the locking member is configured to be received in the receiving portion after the cover rotates toward the base, the sensing member is triggered, and the control device controls the locking member to lock in the receiving portion, thereby preventing the cover from rotating away from the base.

2. The electronic device enclosure of claim 1, wherein the locking member comprises a mounting portion and a locking portion movably coupled to the mounting portion, the mounting portion presses the receiving portion, the sensing member is triggered, thus the control device controls the locking portion to extend out of the mounting portion and lock in the receiving portion, thereby preventing the cover from rotating away from the base.

3. The electronic device enclosure of claim 2, wherein the receiving portion comprises a sensing portion and an engaging portion extending from the sensing portion, the mounting portion presses the sensing portion, the control device controls the locking portion to extend out of the mounting portion and lock in the engaging portion after the sensing member is triggered.

4. The electronic device enclosure of claim 3, wherein the receiving portion is substantially L-shaped.

5. The electronic device enclosure of claim 1, wherein the receiving portion is a groove and is defined inwardly from the base.

6. The electronic device enclosure of claim 1, wherein the control device comprises a control chip and a driving member, the control chip drives the driving member to control the locking member to lock in the receiving portion.

7. The electronic device enclosure of claim 6, wherein the locking member comprises a mounting portion and a locking portion movably coupled to the mounting portion, the driving member controls the locking portion to extend out of the mounting portion and lock in the receiving portion.

8. The electronic device enclosure of claim 1, wherein an unlocking device is mounted to the cover and is configured to send an open signal to the control chip, the control device controls the locking member to disengage from the receiving portion after receiving the open signal, thus the cover can rotate away from the base.

9. The electronic device enclosure of claim 8, wherein the control device comprises a control chip and a driving member, the control chip controls the locking member to disengage from the receiving portion after the control chip receives the open signal to drive the driving member.

10. The electronic device enclosure of claim 8, wherein the unlocking device is a fingerprint identification device, the unlocking device is configured to store a reference range corresponding to fingerprint information and configured to receive a current value after sensing the fingerprint information and compare the current value with the reference range, the unlocking device sends the open signal to the control chip when the current value is in the reference range.

11. An electronic device enclosure comprising:
a cover;
a base defining a receiving portion;
a locking member mounted to the cover;
a sensing member mounted to the base; and
a control device mounted to the base,
wherein the locking member is configured to be received in the receiving portion after the cover rotates toward the base, the sensing member is triggered and sends a closed signal to control device, thus the control device controls the locking member to lock in the receiving portion, thereby preventing the cover from rotating away from the base.

12. The electronic device enclosure of claim 11, wherein the locking member comprises a mounting portion mounted to the cover and a locking portion movably coupled to the mounting portion, the mounting portion presses the receiving portion, the sensing member is triggered, the control device controls the locking portion to extend out of the mounting portion and lock in the receiving portion after the sensing member sends the closed signal, thereby preventing the cover from rotating away from the base.

13. The electronic device enclosure of claim 12, wherein the receiving portion comprises a sensing portion and an engaging portion extending from the sensing portion, the mounting portion presses the sensing portion, the sensing member is triggered, the control device controls the locking portion to extend out of the mounting portion and lock in the engaging portion after the sensing member sends the closed signal.

14. The electronic device enclosure of claim 13, wherein the engaging portion extends perpendicular from the sensing portion, the receiving portion is substantially L-shaped.

15. The electronic device enclosure of claim 11, wherein the sensing member is a pressure sensor.

16. The electronic device enclosure of claim 11, wherein the control device comprises a control chip and a driving member, the control chip drives the driving member to control the locking member to lock in the receiving portion.

17. The electronic device enclosure of claim 16, wherein the locking member comprises a mounting portion and a locking portion movably coupled to the mounting portion, the driving member controls the locking portion to extend out of the mounting portion and lock in the receiving portion.

18. The electronic device enclosure of claim 11, wherein an unlocking device is mounted to the cover and is configured to send an open signal to the control chip, the control device controls the locking member to disengage from the receiving portion after receiving the open signal, thus the cover can rotate away from the base.

19. The electronic device enclosure of claim 18, wherein the control device comprises a control chip and a driving member, the control chip controls the locking member to disengage from the receiving portion after the control chip receives the open signal to drive the driving member.

20. The electronic device enclosure of claim 18, wherein the unlocking device is a fingerprint identification device, the unlocking device is configured to collect fingerprint information from users and store a reference range corresponding to the fingerprint information of users, the unlocking device is also configured to receive a current value after sensing the fingerprint information and compare the current value with the reference range; the unlocking device sends the open signal to the control chip when the current value is in the reference range.
